(19) United States
(12) Patent Application Publication
(10) Pub. No.: US 2015/0094063 A1
(43) Pub. Date: Apr. 2, 2015

(54) DEVICES AND METHODS FOR FACILITATING OPTIMIZED HAND DOWN OPERATIONS IN HYBRID ACCESS TERMINALS

(71) Applicant: QUALCOMM Incorporated, San Diego, CA (US)

(72) Inventors: Yuming Hu, San Diego, CA (US); Chintan Pravin Turakhia, San Diego, CA (US)

(73) Assignee: QUALCOMM Incorporated, San Diego, CA (US)

(21) Appl. No.: 14/040,049

(22) Filed: Sep. 27, 2013

(51) Int. Cl. H04W 36/14

(52) U.S. Cl. CPC H04W 36/14
USPC 455/436

(57) ABSTRACT

Access terminals are adapted to facilitate hand down procedures between a preferred radio access network and a secondary radio access network. According to various examples, an access terminal may attempt to sequentially access one or more other carriers and/or one or more other sectors associated with the preferred radio access network before handing down to a secondary radio access network. According to additional examples, an access terminal that is instructed to hand down from a preferred radio access network to a secondary radio access network may attempt to sequentially access one or more carriers and/or one or more sectors associated with the secondary radio access network. Other aspects, embodiments, and features are also included.

### TECHNICAL FIELD

The following relates generally to wireless communications, and more specifically to methods and devices for facilitating hand down operations in hybrid access terminals operating in a wireless communications system.

### BACKGROUND

Wireless communications systems are widely deployed to provide various types of communication content such as voice, video, packet data, messaging, broadcast, and so on. These systems may be accessed by various types of devices adapted to facilitate wireless communications, where multiple devices share the available system resources (e.g., time, frequency, and power). Examples of such wireless communications systems include code-division multiple access (CDMA) systems, time-division multiple access (TDMA) systems, frequency-division multiple access (FDMA) systems and orthogonal frequency-division multiple access (OFDMA) systems. Multiple types of devices are adapted to utilize such wireless communications systems. Such devices may be generally referred to as access terminals.

A service provider (or network operator) may deploy multiple radio access technologies in a given wireless communication system to enable users of differently capable access terminals to access the service provider's system. For example, a service provider may deploy radio access technologies such as a 4^{th} generation (4G) LTE network (as defined by the 3^{rd} Generation Partnership Project (3GPP), a 3^{rd} generation (3G) EV-DO network (as defined by the 3^{rd} Generation Partnership Project 2 (3GPP2) standards body), and/or a 2^{nd} generation (2G) cdma2000 1× network (also defined by 3GPP2).

In some instances, access terminals may be capable of communicating on two or more different radio access technologies. Such access terminals are often referred to as hybrid devices or hybrid access terminals. One common hybrid access terminal may be referred to as a 1×/DO hybrid access terminal, which is capable of communicating on both 3G EV-DO networks and on 2G cdma2000 1× networks. Another example of a hybrid access terminal may be referred to as a LTE/DO hybrid access terminal, which is capable of communicating on both 4G LTE networks and 3G EV-DO networks.

As hybrid access terminals become more prevalent, it is desirable to provide features that can improve the operation and user experience with such devices.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure facilitate optimized hand down operations on hybrid access terminals.

According to at least on aspect of the disclosure, access terminals may include a communications interface and a storage medium, each coupled with a processing circuit. The processing circuit may be adapted to attempt to access a first carrier on a first sector for a preferred radio access network via the communications interface. Instead of handing down to a secondary radio access network in response to failure to access the first carrier, the processing circuit may be adapted to sequentially attempt to access one or more other carriers on the first sector via the communications interface.

Further aspects provide methods operational on access terminals and/or access terminals including means to perform such methods. One or more examples of such methods may include engaging in a data call utilizing a first carrier on a first sector corresponding to a preferred radio access network. The data call may be idled, and attempt made to access the first carrier. Prior to handing down to a secondary radio access network when the attempt to access the first carrier fails, attempting to sequentially access one or more other carriers on the first sector.

Still further aspects include processor-readable storage mediums comprising programming executable by a processing circuit. According to one or more examples, such programming may be adapted for causing the processing circuit to engage in a data call utilizing a first carrier on a first sector corresponding to a preferred radio access network. The programming may further be adapted for causing the processing circuit to idle the data call and attempt to access the first carrier. Additionally, the programming may be adapted for causing the processing circuit to attempt to sequentially access one or more other carriers on the first sector prior to handing down to a secondary radio access network and in response to failure to access the first carrier.

Additional aspects of the disclosure include access terminals with a communications interface and a storage medium, each coupled with a processing circuit. The processing circuit may be adapted to attempt to access a first sector corresponding to a preferred radio access network via the communications interface. Instead of handing down to a secondary radio access network in response to failure to access the first sector, the processing circuit may be adapted to sequentially attempt to access one or more neighboring sectors via the communications interface.

Further aspects provide methods operational on access terminals and/or access terminals including means to perform such methods. One or more examples of such methods may include engaging in a data call utilizing a carrier on a first sector corresponding to a preferred radio access network. The data call may be idled, and attempt made to access the first sector. Prior to handing down to a secondary radio access network when the attempt to access the first sector fails, attempting to sequentially access one or more neighboring sectors.

Still further aspects include processor-readable storage mediums comprising programming executable by a processing circuit. According to one or more examples, such programming may be adapted for causing the processing circuit to attempt to access a first sector corresponding to a preferred radio access network. The programming may further be adapted for causing the processing circuit to attempt to sequentially access one or more neighboring sectors prior to handing down to a secondary radio access network and in response to failure to access the first sector.

Yet additional aspects of the disclosure include access terminals with a communications interface and a storage medium, each coupled with a processing circuit. The processing circuit may be adapted to obtain an indication to hand down from a preferred radio access network to a secondary radio access network. In response to the indication to hand down to the secondary radio access network, a carrier priority table may be built. The carrier priority table may correspond to a plurality of carriers on a sector of the secondary radio access network. The processing circuit may further be adapted to sequentially attempt to access the carriers via the communications interface according to the carrier priority table.

Further aspects provide methods operational on access terminals and/or access terminals including means to perform such methods. One or more examples of such methods may include obtaining an indication to hand down from a preferred radio access network to a secondary radio access network. A carrier priority table corresponding to a plurality of carriers on a sector of the secondary radio access network may be built. Attempts may then be made to access the plurality of carriers on the sector of the secondary radio access network in sequence according to the carrier priority table.

Still further aspects include processor-readable storage mediums comprising programming executable by a processing circuit. According to one or more examples, such programming may be adapted for causing the processing circuit to obtain an indication to hand down from a preferred radio access network to a secondary radio access network. In response to such an indication, the programming may be adapted for causing the processing circuit to attempt to build a carrier priority table corresponding to a plurality of carriers on a sector of the secondary radio access network, and attempt to access the plurality of carriers on the sector of the secondary radio access network in sequence according to the carrier priority table.

Yet additional aspects of the disclosure include access terminals with a communications interface and a storage medium, each coupled with a processing circuit. The processing circuit may be adapted to obtain an indication to hand down from a preferred radio access network to a secondary radio access network. In response to the indication to hand down to the secondary radio access network, the processing circuit may be adapted to build a neighboring sector priority table corresponding to a first sector of the secondary radio access network. The processing circuit may then attempt to access the first sector on the secondary radio access network and, if the first sector fails, may attempt to access the one or more neighboring sectors on the secondary radio access network in sequence according to the neighboring sector priority table.

Further aspects provide methods operational on access terminals and/or access terminals including means to perform such methods. One or more examples of such methods may include obtaining an indication to hand down from a preferred radio access network to a secondary radio access network. In response to the indication, a neighboring sector priority table corresponding to a first sector of the secondary radio access network may be built. Access to the first sector on the secondary radio access network may be attempted and, if the access to the first sector fails, attempts to access the one or more neighboring sectors on the secondary radio access network may be made in sequence according to the neighboring sector priority table.

Still further aspects include processor-readable storage mediums comprising programming executable by a processing circuit. According to one or more examples, such programming may be adapted for causing the processing circuit to obtain an indication to hand down from a preferred radio access network to a secondary radio access network. In response to the indication, the programming may be adapted for causing the processing circuit to build a neighboring sector priority table corresponding to a first sector of the secondary radio access network. The programming may further be adapted for causing the processing circuit to attempt to access the first sector on the secondary radio access network and, if the access to the first sector fails, attempt to access the one or more neighboring sectors on the secondary radio access network in sequence according to the neighboring sector priority table.

Other aspects, features, and embodiments associated with the present disclosure will become apparent to those of ordinary skill in the art upon reviewing the following description in conjunction with the accompanying figures.

### DRAWINGS

FIG. 1 is a block diagram of a network environment in which one or more aspects of the present disclosure may find application.

FIG. 2 is a block diagram illustrating select components of the wireless communication system of FIG. 1 according to at least one example.

FIG. 3 is a block diagram illustrating base stations associated with different radio access networks, as well as carriers associated with one of the base stations.

FIG. 4 is a block diagram illustrating multiple base stations associated with a first radio access network and another base station associated with a second radio access network.

FIG. 5 is a block diagram illustrating select components of an access terminal according to at least one example of the present disclosure.

FIG. 6 is a flow diagram illustrating at least one example of a method operational on an access terminal

FIG. 7 is a flow diagram depicting at least one example of a method for generating a carrier priority table.

FIG. 8 is a flow diagram illustrating at least one other example of a method operational on an access terminal

FIG. 9 is a flow diagram depicting at least one example of a method for generating a neighboring sector priority table.

FIG. 10 is a flow diagram illustrating at least one other example of a method operational on an access terminal

FIG. 11 is a flow diagram illustrating at least one other example of a method operational on an access terminal

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of telecommunication systems, network architectures, and communication standards. Certain aspects of the disclosure are described below for specific protocols and systems (e.g., LTE, EV-DO, cdma2000 1×), and related terminology may be found in much of the following description. However, those of ordinary skill in the art will recognize that one or more aspects of the present disclosure may be employed and included in one or more other wireless communication protocols and systems.

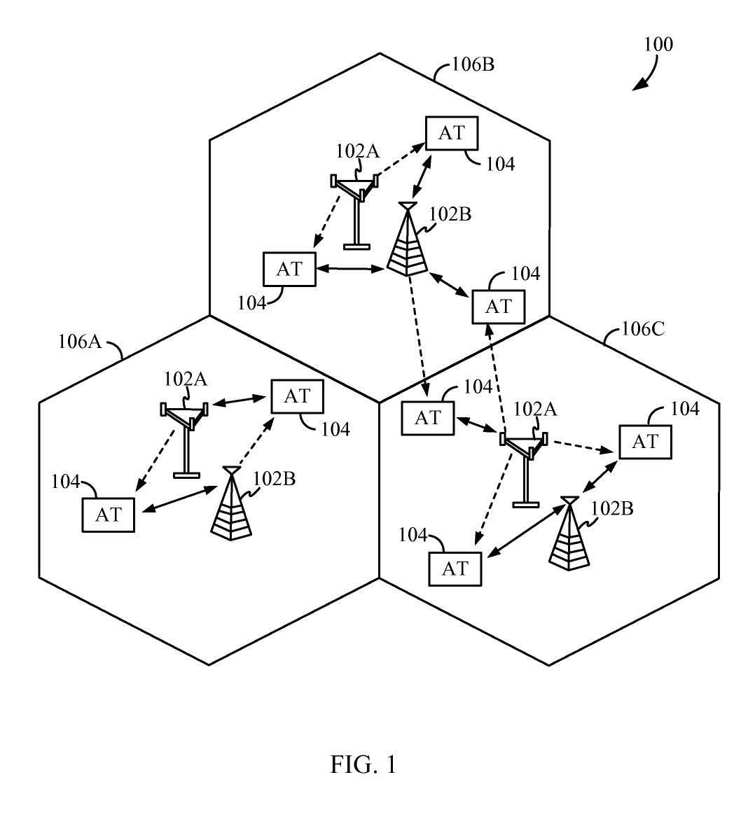

Referring now to FIG. 1, a block diagram of a network environment in which one or more aspects of the present disclosure may find application is illustrated. The wireless communications system 100 is adapted to facilitate wireless communication between one or more base stations 102 (e.g., 102A and 102B) and access terminals 104. The base stations 102 and access terminals 104 may be adapted to interact with one another through wireless signals. In some instances, such wireless interaction may occur on multiple carriers (waveform signals of different frequencies). Each modulated signal may carry control information (e.g., pilot signals), overhead information, data, etc.

In this example, the wireless communications system 100 includes two radio access technologies (RATs). The first radio access technology may employ base stations 102A that support radio communication for access terminals 104 located within the coverage of these base stations 102A. Similarly, the second radio access technology includes base stations 102B that support radio communication for access terminals 104 located within the coverage of these base stations 102B. Base stations 102A and 102B may be located at different sites or co-located at the same site.

The base stations 102 (e.g., 102A, 102B) can wirelessly communicate with the access terminals 104 via a base station antenna. The base stations 102 may each be implemented generally as a device adapted to facilitate wireless connectivity (for one or more access terminals 104) to the wireless communications system 100. Such a base station 102 may also be referred to by those skilled in the art as a base transceiver station (BTS), a radio base station, a radio transceiver, a transceiver function, a basic service set (BSS), and extended service set (ESS), a node B, a femto cell, a pico cell, or some other suitable terminology.

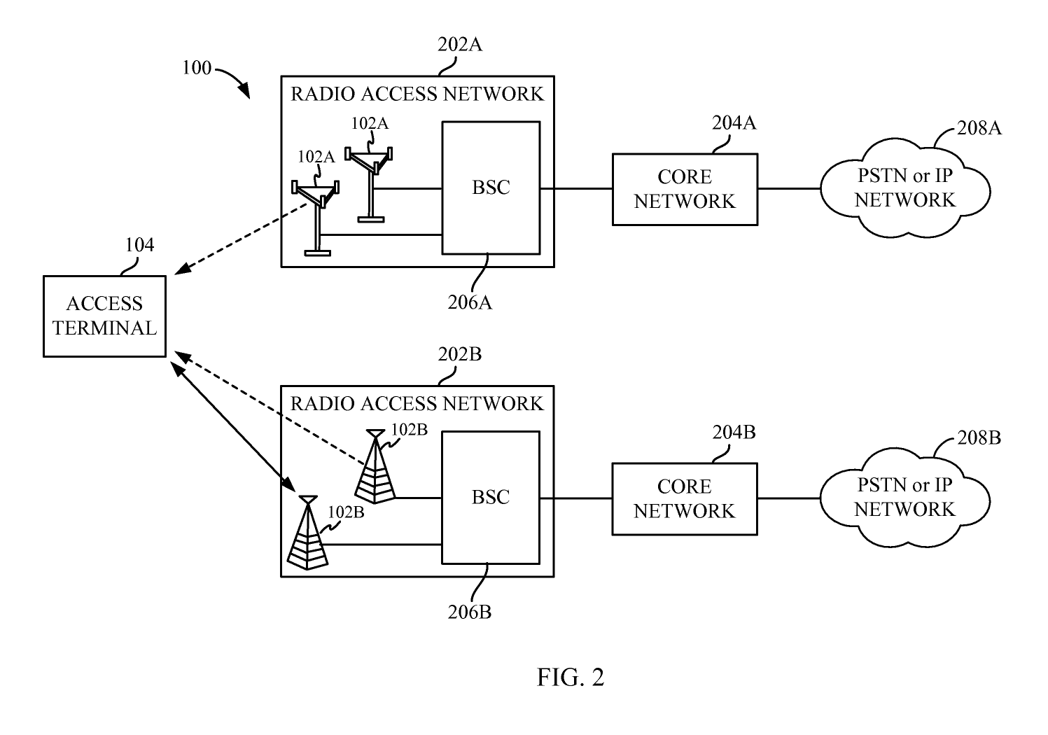

The base stations 102 (e.g., 102A and 102B) are configured to communicate with the access terminals 104 under the control of a respective base station controller (see FIG. 2). Each of the base station 102 sites can provide communication coverage for a respective geographic area. The coverage area 106 for each base station 102 here is identified as sectors or cells 106A, 106B, or 106C. In various examples, the system 100 may include base stations 102 of different types.

One or more access terminals 104 may be dispersed throughout the coverage areas 106. Each access terminal 104 may communicate with one or multiple base stations 102 at any given moment. In FIG. 1, a solid line with arrows indicates communication between an access terminal 104 and a base station 102. A dashed line with one arrow indicates reception of pilot and/or signaling (e.g., pages) by an access terminal 104 from the base station 102.

An access terminal 104 may generally include one or more devices that communicate with one or more other devices through wireless signals. Such an access terminal 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. An access terminal 104 may include a mobile terminal and/or an at least substantially fixed terminal Examples of an access terminal 104 include a mobile phone, a pager, a wireless modem, a personal digital assistant, a personal information manager (PIM), a personal media player, a palmtop computer, a laptop computer, a tablet computer, a television, an appliance, an e-reader, a digital video recorder (DVR), a machine-to-machine (M2M) device, and/or other communication/computing device which communicates, at least partially, through a wireless or cellular network.

Turning to FIG. 2, a block diagram illustrating select components of the wireless communication system 100 is depicted according to at least one example. As illustrated, the base stations 102A and 102B are included as at least a part of a respective radio access network (RAN) 202A and 202B employing different radio access technologies. The radio access networks (RAN) 202A and 202B are generally adapted to manage traffic and signaling between one or more access terminals 104 and one or more other network entities, such as network entities included in a core network 204A or 204B. The radio access networks 202A and 202B may, according to a particular radio access technology implementation, be referred to by those skill in the art as a base station subsystem (BSS), an access network, a GSM Edge Radio Access Network (GERAN), a UMTS Terrestrial Radio Access Network (UTRAN), etc.

In addition to one or more base stations 102A or 102B, each radio access network 202A and 202B can include at least one respective base station controller (BSC) 206A, 206B, which may also be referred to by those of skill in the art as a radio network controller (RNC). The base station controllers 206A, 206B are generally responsible for the establishment, release, and maintenance of wireless connections within one or more coverage areas associated with the base stations 102A, 102B connected to the base station controller 206A, 206B.

The base station controllers 206A, 206B can be communicatively coupled to one or more nodes or entities of the respective core networks 204A, 204B. Each core network 204A, 204B provides access to a public switched telephone network (PSTN) (e.g., via a mobile switching center/visitor location register (MSC/VLR)) and/or to an IP network (e.g., via a packet data switching node (PDSN)) 208A, 208B.

By way of example only, the first radio access technology may be implemented by the radio access network 202A employing 2G cdma2000 communication standards, while the second radio access technology may be implemented by the radio access network 202B employing 3G EV-DO communication standards. In another example, the first radio access technology may be implemented by the radio access network 202A employing 3G EV-DO communication standards, while the second radio access technology may be implemented by the radio access network 202B employing 4G LTE communication standards. As noted previously, the various features described herein may be employed with any of a number of different communications standards.

As depicted in FIG. 1, the coverage areas of the two or more radio access networks 202A, 202B employing different radio access technologies may overlap within a geographical region. In such instances, the access terminals 104 may be under the coverage of all the radio access networks 202A, 202B at any given moment. When one or more of the access terminals 104 are implemented as hybrid access terminals 104, such hybrid access terminals 104 may be capable of accessing either or both of the radio access networks 202A, 202B at any given moment.

Typically, to provide a relatively better user experience, it is desirable for a hybrid access terminal 104 to conduct a data session on whichever radio access network 202A, 202B provides the fastest data transmission speeds. As used herein, the faster or otherwise more desirable radio access network will be referred to as the “preferred radio access network,” and the less desirable radio access network will be referred to as the “secondary radio access network.”

For various reasons, such as a dropped call or reduced capacity on the preferred radio access network 202A, 202B, a “hand down” operation may occur. A “hand down” operation refers to a redirection or handover operation from the preferred radio access network to the secondary radio access network. For example, one frequent hand down operation for 1×/DO hybrid access terminal 104, is a hand down from the preferred 3G EV-DO radio access network to the secondary 2G cdma2000 1× radio access network. Another example may be for a LTE/DO hybrid access terminal 104, where a hand down from a preferred 4G LTE radio access network to secondary 3G EV-DO radio access network may occur.

One common reason for a hand down from an EV-DO radio access network to a cdma2000 1× radio access network may occur when loading at the EV-DO radio access network is relatively high, leading to significant deterioration of user experience. For example, the access terminal 104 may experience an access failure on the EV-DO radio access network. That is, due to a dropped call (after a connection is dropped or released), or when a dormancy timer expires, the hybrid 1×/DO access terminal 104 disconnects from the EV-DO radio access network and goes idle on the EV-DO carrier. Next, if the hybrid 1×/DO access terminal 104 needs to transmit data, the access terminal 104 attempts to set up a connection to the EV-DO radio access network to enable upload of that data. However, if the EV-DO connection setup attempt fails several times (e.g., 2 times), the hybrid 1×/DO access terminal 104 generally tunes to the cdma2000 1× radio access network and attempts to set up a data connection on that radio access network.

In some instance, when a hybrid access terminal 104 is utilizing the secondary radio access network, the access terminal 104 is adapted to not search the preferred radio access network until the data call on the secondary radio access network is released. As a result, the user will have to experience the low throughput data transmissions associated with the secondary radio access network for a relatively long period of time. As the number of access terminals 104 continue to increase within wireless communications system 100, this issue is becoming more prevalent, especially within densely populated areas.

According to at least one aspect of the disclosure, access terminals can be adapted to facilitate additional opportunities for the access terminal to remain on a preferred radio access network before handing down to a secondary radio access network. That is, access terminals can be adapted to continue trying to access the preferred radio access network before handing down to the secondary radio access network to originate a data call. Such features can increase the likelihood of using the preferred radio access network, facilitating a better user experience with the better data rates provided by the preferred radio access network.

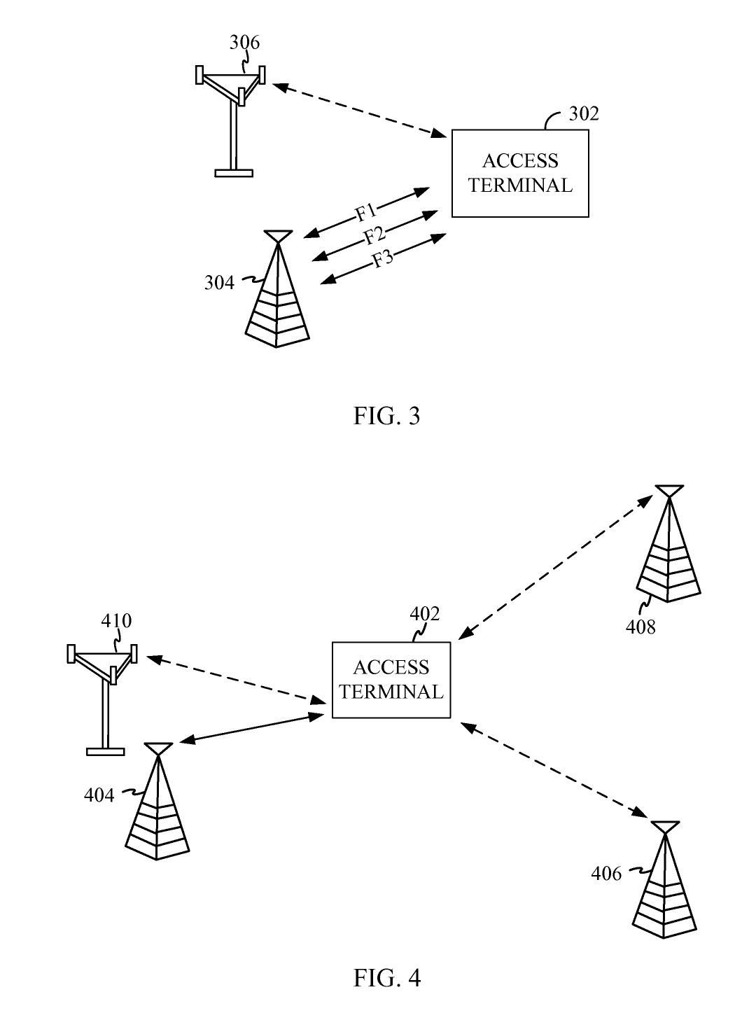

FIG. 3 is a block diagram illustrating base stations associated with different radio access networks, as well as carriers associated with one of the base stations. With reference to FIG. 3, an example for facilitating additional opportunities for an access terminal 302 to remain on a preferred radio access network before handing down to a secondary radio access network is described. In this example, a first base station 304 is associated with the preferred radio access network and a second base station 306 is associated with the secondary radio access network, where respective coverage areas associated with the two base stations 304, 306 are at least partially overlapping so that the access terminal 302 can access either network at its depicted location.

In this example, when a hand down is indicated at the access terminal 302 from the preferred radio access network (e.g., base station 304) to the secondary radio access network (e.g., base station 306), the access terminal 302 can try additional carriers with the preferred radio access network before handing down to the secondary radio access network. For instance, in the depicted example there are three carriers for the preferred radio access network, F1, F2, and F3 shown available with the base station 304. If a hand down is indicated when the access terminal 302 is on the first carrier, F1, the access terminal 302 can try the other two carriers, F2 and F3, prior to handing down to the secondary radio access network on the base station 306.

For instance, if the preferred radio access network with the base station 304 is an EV-DO radio access network with the three carriers, F1, F2, and F3, and if the access terminal 302 was idling on the first carrier F1 after a call is dropped or released, the access terminal 302 may attempt to set up a new connection with the preferred radio access network on the first carrier, F1, when there is data to be sent. After a predetermined number of failed set up attempts on the first carrier, F1 (e.g., three failed call attempts), a hand down may be indicated at the access terminal 304. Instead of switching to the base station 306 associated with the secondary radio access network employing a cdma2000 1× technology, the access terminal 302 is adapted to try carriers F2 and F3. If all of the other carriers fail too, then the access terminal 302 can hand down to the base station 306 associated with the secondary radio access technology.

In some examples, the access terminal 302 may build a carrier priority table for use in determining which carriers to try in which order, as described in more detail below. In other examples, the access terminal 302 may simply try each carrier in no specific order until one is successful, or until all carriers have been tried, as also described in more detail below.

FIG. 4 is a block diagram illustrating multiple base stations associated with a first radio access network and another base station associated with a second radio access network. With reference to FIG. 4, another example for facilitating additional opportunities for an access terminal 402 to remain on a preferred radio access network before handing down to a secondary radio access network is described. In this example, a plurality of base stations 404, 406, 408 are associated with the preferred radio access network and another base station 410 is associated with the secondary radio access network, where respective coverage areas associated with the base stations 404 and 410 are at least partially overlapping so that the access terminal 402 can access either network at its depicted location. Each of base stations 404, 406, and 408 associated with the preferred radio access network represents a respective sector.

In this example, when a hand down is indicated at the access terminal 402 from the preferred radio access network (e.g., base station 404) to the secondary radio access network (e.g., base station 410), the access terminal 402 can try other sectors (e.g., other base stations 404, 406, 408) associated with the preferred radio access network before handing down to the secondary radio access network. For instance, in the depicted example there are three sectors or base stations 404, 406, and 408 associated with the preferred radio access network. If a hand down is indicated when the access terminal 402 is on a first base station 404, the access terminal 402 can be adapted to try the other two base stations 406, 408 prior to handing down to the base station 410 associated with the secondary radio access network.

For instance, if the preferred radio access network associated with the base stations 404, 406, and 408 is an EV-DO radio access network, and if the access terminal 402 was idling on the base station 404 after a call is dropped or released, the access terminal 402 may attempt to set up a new connection with the same sector (e.g., base station 404) on the preferred radio access network when there is data to be sent. After a predetermined number of failed set up attempts with the base station 404 (e.g., three failed call attempts), a hand down may be indicated at the access terminal 402. Instead of switching to the base station 410 associated with the secondary radio access network employing a cdma2000 1× technology, the access terminal 402 is adapted to try neighboring sectors (e.g., neighboring base stations 406 and 408). If all of the other sectors fail too, then the access terminal 402 can hand down to the base station 410 associated with the secondary radio access technology.

In some examples, the access terminal 402 may build a sector priority table for use in determining which sectors to try in which order, as described in more detail below. In other examples, the access terminal 402 may simply try each neighboring sector in no specific order until one is successful, or until all sectors have been tried, as also described in more detail below.

According to at least one other aspect of the disclosure, access terminals can be adapted to optimize the hand down to the secondary radio access network. That is, access terminals are adapted to improve the rate of successful hand downs to the secondary radio access network.

With reference back to FIG. 3, an example of an access terminal 302 performing a hand down from the preferred radio access network to the secondary radio access network can be described. In this hand down example, the base station 306 is associated with the preferred radio access network and the base station 304 is associated with the secondary radio access network. When the access terminal 302 obtains an indication to hand down, the access terminal 302 can be adapted to identify each of the carriers (e.g., F1, F2, and F3) associated with the base station 304 for the secondary radio access network prior to handing down to the base station 304. The access terminal 302 can then attempt to connect to the base station 304 on each of the carriers, F1, F2, and F3, until one is successful.

For instance, the preferred radio access network associated with the base station 306 may be LTE and the secondary radio access network associated with the base station 304 may be EV-DO with three carriers, F1, F2, and F3. When the access terminal 302 receives an indication to hand down from the preferred LTE radio access network to the secondary EV-DO radio access network on the base station 304, the access terminal 302 can attempt to set up a call on one carrier F1, F2, F3 at a time until one of the carriers is successful. In some examples, the access terminal 302 may build a carrier priority table for use in determining which carriers to try in which order, as described in more detail below. In other examples, the access terminal 302 may simply try each carrier in no specific order until one is successful, as also described in more detail below.

With reference to again to FIG. 4, another example of an access terminal 302 performing a hand down from the preferred radio access network to the secondary radio access network can be described. In this hand down example, the base station 410 is associated with the preferred radio access network and the base stations 404, 406, and 408 are associated with the secondary radio access network. When the access terminal 402 obtain an indication to hand down, the access terminal 402 can be adapted to attempt to connect to each of a plurality of sectors associated with the secondary radio access network until a sector is successful.

For instance, the preferred radio access network associated with the base station 410 can be an LTE radio access network and the secondary radio access network associated with the base stations 404, 406, and 408 can be an EV-DO radio access network. When a hand down is indicated at the access terminal 402, the access terminal 402 can be adapted to try a plurality of sectors (e.g., base stations 404, 406, and 408) until one is successful. In some examples, the access terminal 402 may build a sector priority table for use in determining which sectors to try in which order, as described in more detail below. In other examples, the access terminal 402 may simply try each neighboring sector in no specific order until one is successful, as also described in more detail below.

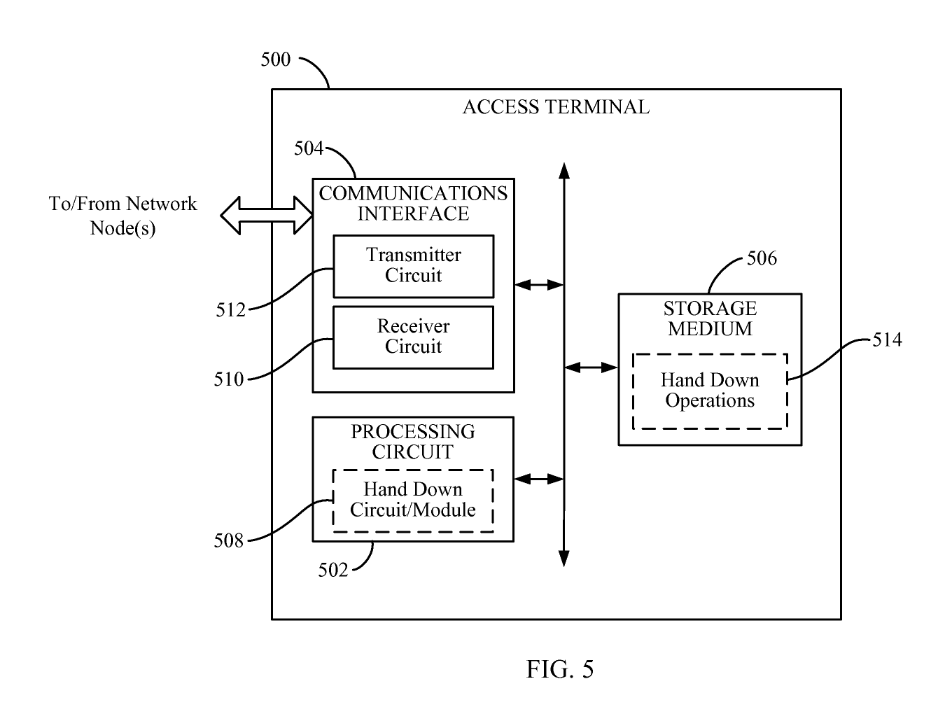

Turning to FIG. 5, a block diagram is shown illustrating select components of an access terminal 500 according to at least one example of the present disclosure. The access terminal 500 includes a processing circuit 502 coupled to or placed in electrical communication with a communications interface 504 and a storage medium 506.

The processing circuit 502 is arranged to obtain, process and/or send data, control data access and storage, issue commands, and control other desired operations. The processing circuit 502 may include circuitry adapted to implement desired programming provided by appropriate media in at least one example. For example, the processing circuit 502 may be implemented as one or more processors, one or more controllers, and/or other structure configured to execute executable programming Examples of the processing circuit 502 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 502 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 502 are for illustration and other suitable configurations within the scope of the present disclosure are also contemplated.

The processing circuit 502 is adapted for processing, including the execution of programming, which may be stored on the storage medium 506. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 502 may include a hand down circuit or module 508. The hand down circuit or module 508 may include circuitry and/or programming (e.g., programming stored on the storage medium 506) adapted to perform one or more of the hand down procedures described herein.

The communications interface 504 is configured to facilitate wireless communications of the access terminal 500. For example, the communications interface 504 may include circuitry and/or programming adapted to facilitate the communication of information bi-directionally with respect to one or more wireless network devices (e.g., network nodes). According to at least one aspect of the present disclosure, the communications interface 504 is adapted to facilitate communications on two or more radio access network technologies. By way of example only, the communications interface 504 may be configured for EV-DO and 1× radio access network technologies (e.g., 1×/DO hybrid), LTE and EV-DO radio access network technologies (e.g., LTE/DO hybrid) or other combinations. The communications interface 504 may be coupled to one or more antennas (not shown), and includes wireless transceiver circuitry, including at least one receiver circuit 510 (e.g., one or more receiver chains) and/or at least one transmitter circuit 512 (e.g., one or more transmitter chains).

The storage medium 506 may represent one or more computer-readable, machine-readable, and/or processor-readable devices for storing programming, such as processor executable code or instructions (e.g., software, firmware), electronic data, databases, or other digital information. The storage medium 506 may also be used for storing data that is manipulated by the processing circuit 502 when executing programming The storage medium 506 may be any available media that can be accessed by a general purpose or special purpose processor, including portable or fixed storage devices, optical storage devices, and various other mediums capable of storing, containing and/or carrying programming. By way of example and not limitation, the storage medium 506 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 506 may be coupled to the processing circuit 502 such that the processing circuit 502 can read information from, and write information to, the storage medium 506. That is, the storage medium 506 can be coupled to the processing circuit 502 so that the storage medium 506 is at least accessible by the processing circuit 502, including examples where the storage medium 506 is integral to the processing circuit 502 and/or examples where the storage medium 506 is separate from the processing circuit 502 (e.g., resident in the access terminal 500, external to the access terminal 500, distributed across multiple entities).

Programming stored by the storage medium 506, when executed by the processing circuit 502, causes the processing circuit 502 to perform one or more of the various functions and/or process steps described herein. For example, the storage medium 506 may include hand down operations 514 adapted to cause the processing circuit 502 to perform one or more of the hand down procedures described herein. Thus, according to one or more aspects of the present disclosure, the processing circuit 502 is adapted to perform (in conjunction with the storage medium 506) any or all of the processes, functions, steps and/or routines for any or all of the access terminals (e.g., access terminal 104, access terminal 302, access terminal 402, access terminal 500) described herein. As used herein, the term “adapted” in relation to the processing circuit 502 may refer to the processing circuit 502 being one or more of configured, employed, implemented, and/or programmed (in conjunction with the storage medium 506) to perform a particular process, function, step and/or routine according to various features described herein.

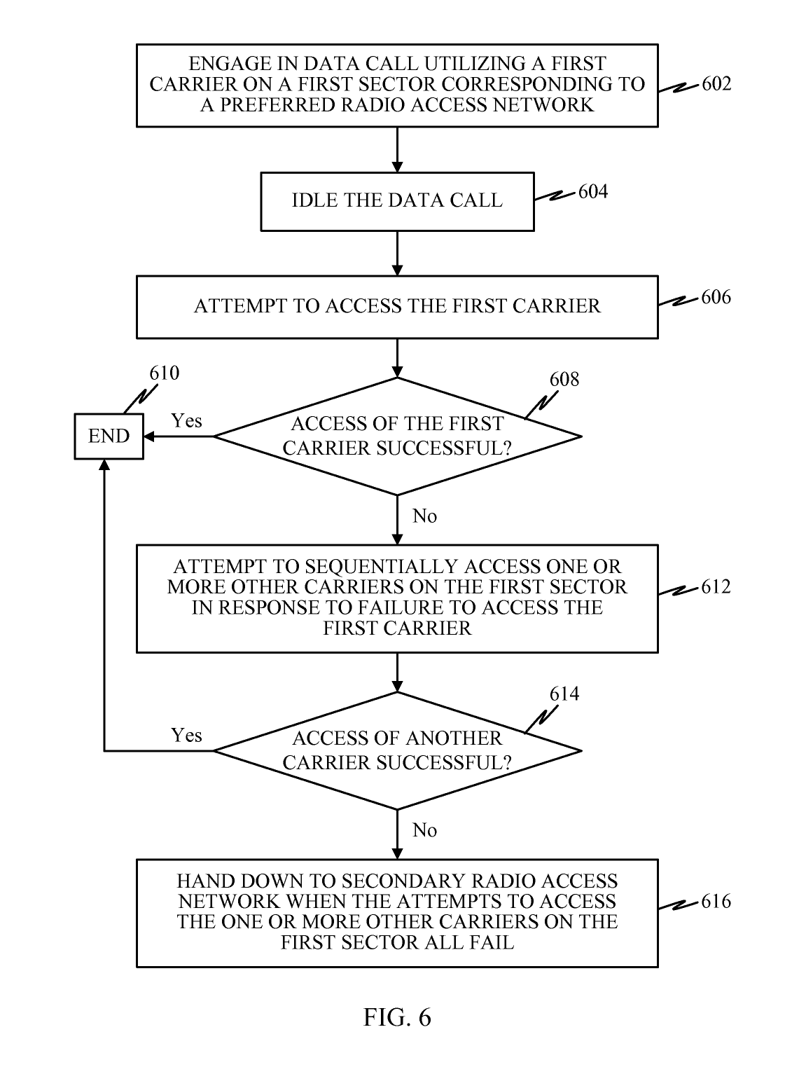

FIG. 6 is a flow diagram illustrating at least one example of a method operational on an access terminal, such as the access terminal 500. Referring to FIGS. 5 and 6, an access terminal 500 can engage in a data call on a first carrier for a first sector corresponding to a preferred radio access network at step 602. For example, the processing circuit 502 may engage in a data call via the communications interface 504. At 604, the access terminal 500 may idle the data call. For example, the data call on the first carrier may be dropped or released, or a dormancy timer may expire, causing the processing circuit 502 to disconnect from the preferred radio access network and to go idle on the first carrier for the first sector.

At 606, the access terminal 500 may attempt to access the first carrier for the first sector. For example, the processing circuit 502 may identify that data is available for transmission. In response to the availability of data for upload, the processing circuit 502 (e.g., the hand down circuit/module 508) executing the hand down operations 514 can attempt to access the first carrier for the first sector via the communications interface 504 to set up a data call.

At 608, the access terminal 500 determines whether access of the first carrier on the first sector was successful. For example, the processing circuit 502 (e.g., the hand down circuit/module 508) executing the hand down operations 514 may attempt to access the first carrier a predetermined number of times (e.g., 2 attempts, 3 attempts, etc.). If the access terminal 500 is able to access the first carrier within the predetermined number of attempts, then the access terminal 500 can end the current process and send the uplink transmissions on the first carrier, at step 610.

On the other hand, if the access terminal 500 is unable to successfully access the first carrier after the predetermined number of attempts, then the access terminal 500 is adapted to attempt to sequentially access one or more other carriers on the first sector at 612, instead of immediately handing down to the secondary radio access network. For example, the processing circuit 502 (e.g., the hand down circuit/module 508) executing the hand down operations 514 may attempt to sequentially access one or more other carriers on the first sector via the communications interface 504.

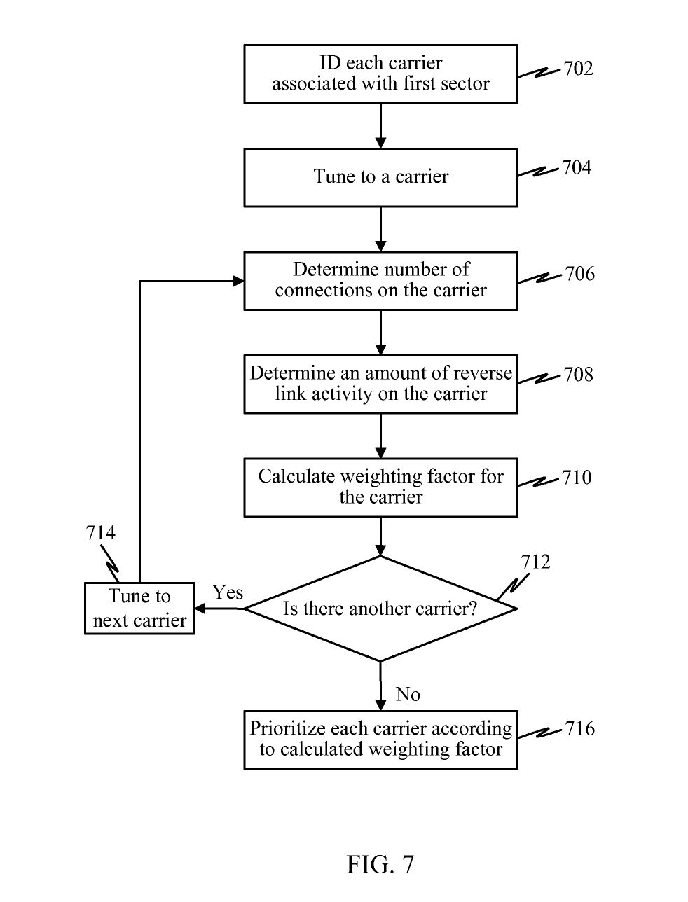

In one example, the processing circuit 502 (e.g., the hand down circuit/module 508) executing the hand down operations 514 can sequentially attempt accessing each carrier at step 612 according to a carrier priority table. In some instances, the processing circuit 502 (e.g., the hand down circuit/module 508) executing the hand down operations 514 may build the carrier priority table. Referring to FIG. 7, a flow diagram is shown depicting at least one example of a method for generating a carrier priority table.

At step 702, the processing circuit 502 (e.g., the hand down circuit/module 508) executing the hand down operations 514 can identify each carrier associated with the first sector. In one example, the processing circuit 502 (e.g., the hand down circuit/module 508) executing the hand down operations 514 can identify each carrier from a Sector Parameters Message broadcast by the preferred radio access network. That is, the processing circuit 502 can receive via the communications interface 504 a Sector Parameters Message, which is one of the overhead messages broadcast by some radio access networks, such as an EV-DO network. Within the Sector Parameters Message is included an indication of the number of carriers that are configured for the sector transmitting the Sector Parameters Message.

With each of the carriers identified, the processing circuit 502 (e.g., the hand down circuit/module 508) executing the hand down operations 514 can determine certain metrics for each carrier. At 704, the processing circuit 502 can tune the communications interface 504 to a first carrier on the list of carriers from the Sector Parameters Message.

For the first carrier, the processing circuit 502 (e.g., the hand down circuit/module 508) executing the hand down operations 514 can determine a number of connections at 706. In some examples, the processing circuit 502 can receive a Quick Config Message for carrier via the communications interface 504. From the Quick Config Message, the processing circuit 502 (e.g., the hand down circuit/module 508) executing the hand down operations 514 can calculate how many active connections there are on the respective carrier by decoding and counting the number of FT Valid bits to determine the number of active connections on the particular carrier.

In other examples, the processing circuit 502 can decode the number of power control commands that are present in the MAC chips for a predetermined number of slots (e.g., 16 slots) on the carrier. In the MAC chips for at least some radio access networks (e.g., EV-DO radio access networks), the power control commands are present and are typically masked with each user's MAC index. Thus, the processing circuit 502 (e.g., the hand down circuit/module 508) executing the hand down operations 514 can compute the number of power control commands present over the predetermined number of slots to determine the number of users on the particular carrier.

At 708, the processing circuit 502 (e.g., the hand down circuit/module 508) executing the hand down operations 514 can also monitor a reverse activity bit for the carrier over a predetermined period of time (e.g., 16 slots). From monitoring period, the processing circuit 502 (e.g., the hand down circuit/module 508) executing the hand down operations 514 can calculate the percentage of time that the reverse activity bit for the particular carrier is set to 1.

At 710, the processing circuit 502 (e.g., the hand down circuit/module 508) executing the hand down operations 514 can calculate a weighting factor value for the carrier based at least in part on the number of active connections and the amount of reverse link activity. By way of example and not limitation, the weighting factor value for each carrier may be calculated according to the equation

$$\frac{( N * C ) + ( M * R )}{C + R} ,$$

where N and M are weight factors with a value between 0 and 1 (e.g., 0<x<1), C represents the number of active connections, and R is a number greater than 0 and less than 1 (e.g., 0<R<1) representing the amount of reverse link activity. In another example, the weighting factor value for each carrier may be calculated according to the equation

$$\frac{( R * C ) + ( C )}{R + C} ,$$

where C again represents the number of active connections and R is again a number greater than 0 and less than 1 (e.g., 0<R<1) representing the amount of reverse link activity.

At 712, the processing circuit 502 (e.g., the hand down circuit/module 508) executing the hand down operations 514 determines whether there is another carrier for the sector. If there is, the processing circuit 502 can tune the communications interface 504 to the next carrier and perform the steps 706, 708, and 710 for that carrier. This can be repeated until all carriers have been evaluated.

After the last carrier is evaluated, and there is no additional carrier for the sector, the processing circuit 502 (e.g., the hand down circuit/module 508) executing the hand down operations 514 can prioritize each carrier according to the calculated weighting factor, where the carrier with the least loading has the highest priority.

With the carrier priority table generated, the processing circuit 502 can attempt to access each carrier in order according to the carrier priority table, where the highest priority carrier is attempted first. In some examples, the processing circuit 502 (e.g., the hand down circuit/module 508) executing the hand down operations 514 may employ a threshold for the weighting factor, to determine whether a carrier is worth trying to access. For instance, if a carrier has a calculated weighting factor that is less than the threshold (e.g., has a loading that is higher than a threshold), the processing circuit 502 (e.g., the hand down circuit/module 508) executing the hand down operations 514 may skip attempts to access that carrier. For example, there may three carriers for the sector, F1, F2, and F3 (see, e.g., FIG. 3). The processing circuit 502 might generate a carrier priority table where F3 is higher than F1, and F1 is higher than F2 (e.g., F3>F1>F2), and where F2 is below the threshold. In this example, if F1 is the original or first carrier at step 606 in FIG. 6, and if the access attempt for F3 fails, the access terminal 500 can skip any access attempts on F2 and instead hand down to the secondary radio access network.

In other examples, if a carrier is prioritized less than the first carrier on which the access terminal 500 originally was connected, then the processing circuit 502 (e.g., the hand down circuit/module 508) executing the hand down operations 514 can skip that carrier. For example, if the carrier priority table is the same as the last example (e.g., F3>F1>F2), and if F1 is the first carrier from step 606 in FIG. 6, then the access terminal 500 can skip an access attempt on F2, since F2 has a higher loading than F 1.

Referring again to FIG. 6, in another example, the processing circuit 502 (e.g., the hand down circuit/module 508) executing the hand down operations 514 may sequentially attempt accessing each carrier at step 612 according to a listing of carriers included in a Sector Parameters Message, without weighting the carriers for any particular priority. Thus, in this example, the processing circuit 502 can receive via the communications interface 504 a Sector Parameters Message. Within the Sector Parameters Message is included an indication of the carriers for the sector transmitting the Sector Parameters Message. The processing circuit 502 (e.g., the hand down circuit/module 508) executing the hand down operations 514 can accordingly attempt to sequentially access the carriers one at a time according to the listing of carriers in Sector Parameters Message.

At step 614, the access terminal 500 determines whether access of the other carriers for the first sector was successful. If the access terminal 500 is able to access one of the other carriers for the first sector, then the access terminal 500 can end the current process and send the uplink transmissions on the successful other carrier, at step 610.

At step 616, if none of the other carriers for the first sector are successfully accessed from step 612, the access terminal 500 can hand down to the secondary radio access network. For instance, the processing circuit 502 can tune the communications interface 504 to the secondary radio access network to attempt accessing one or more carriers on that network.

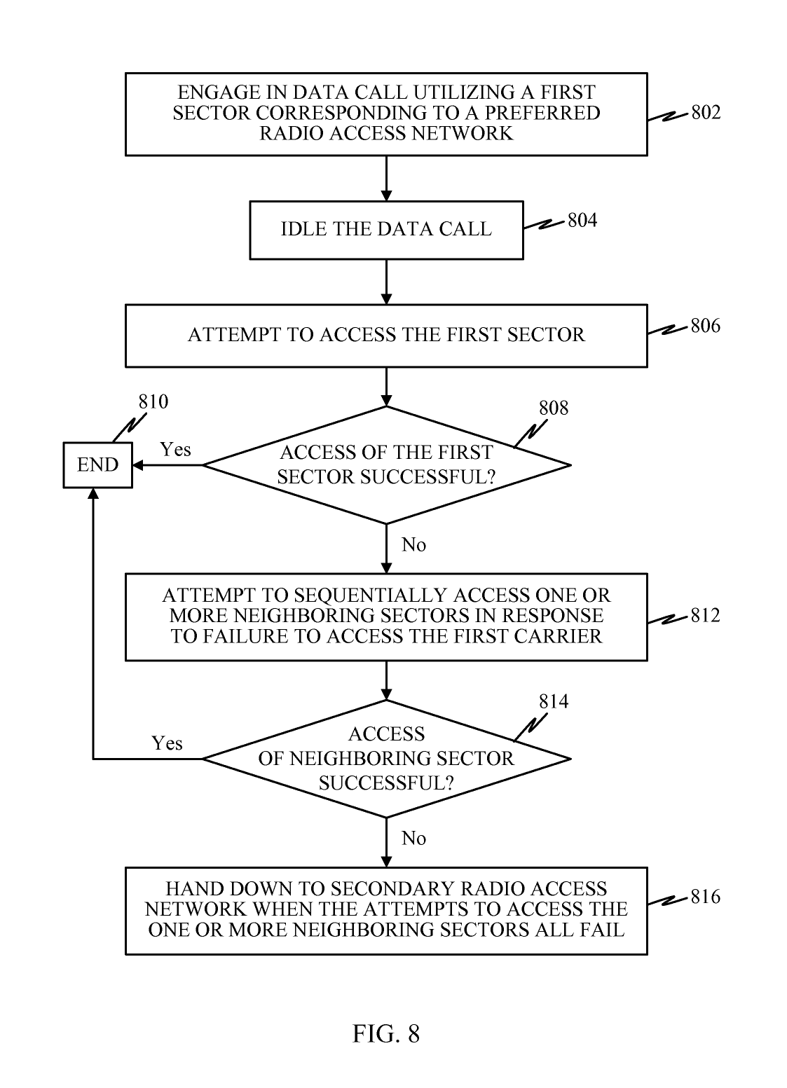

FIG. 8 is a flow diagram illustrating at least one other example of a method operational on an access terminal, such as the access terminal 500. With reference to FIGS. 5 and 8 an access terminal 500 may engage in a data call utilizing a first sector corresponding to a preferred radio access network at 802. For example, the processing circuit 502 may engage in a data call via the communications interface 504. At 804, the access terminal 500 may idle the data call. For example, the data call on the first sector may be dropped or released, or a dormancy timer may expire, causing the processing circuit 502 to disconnect from the preferred radio access network and to go idle on the first sector.

At 806, the access terminal 500 may attempt to access the first sector. For example, the processing circuit 502 may identify that data is available for transmission. In response to the availability of data for upload, the processing circuit 502 (e.g., the hand down circuit/module 508) executing the hand down operations 514 can attempt to access the first sector via the communications interface 504.

At 808, the access terminal 500 determines whether access of the first sector was successful. For example, the processing circuit 502 (e.g., the hand down circuit/module 508) executing the hand down operations 514 may attempt to access the first sector a predetermined number of times (e.g., 2 attempts, 3 attempts, etc.). If the access terminal 500 is able to access the first sector within the predetermined number of attempts, then the access terminal 500 can end the current process and send the uplink transmissions on the first sector, at step 810.

On the other hand, if the access terminal 500 is unable to successfully access the first sector after the predetermined number of attempts, then the access terminal 500 is adapted to attempt to sequentially access one or more neighboring sectors at 812, instead of immediately handing down to the secondary radio access network. For example, the processing circuit 502 (e.g., the hand down circuit/module 508) executing the hand down operations 514 may attempt to sequentially access one or more neighboring sectors via the communications interface 504.

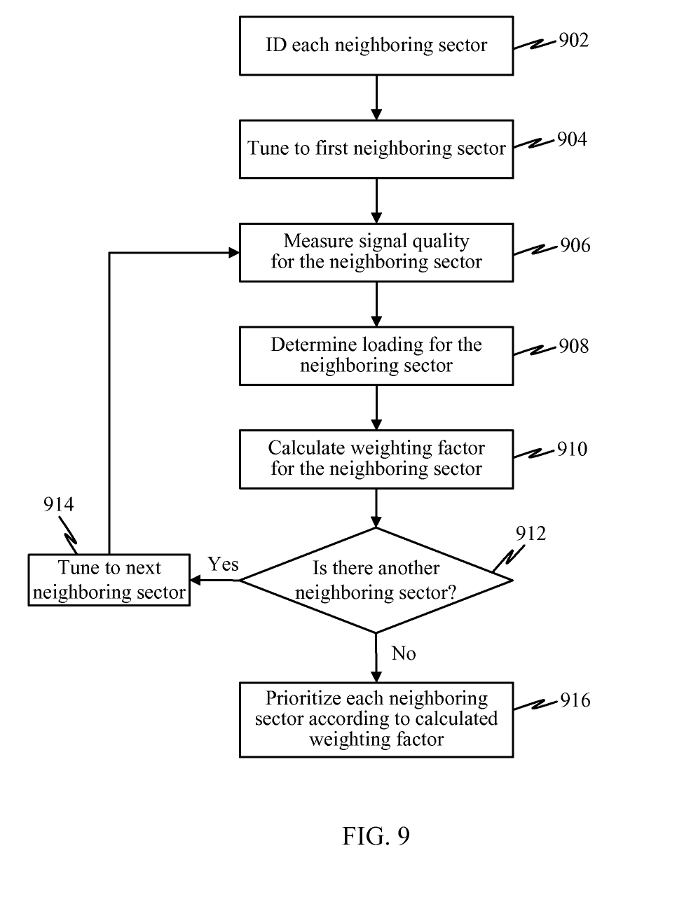

In one example, the processing circuit 502 (e.g., the hand down circuit/module 508) executing the hand down operations 514 can sequentially attempt accessing each neighboring sector at step 812 according to a neighboring sector priority table. In some instances, the processing circuit 502 (e.g., the hand down circuit/module 508) executing the hand down operations 514 may build the neighboring sector priority table. Referring to FIG. 9, a flow diagram is shown depicting at least one example of a method for generating a neighboring sector priority table.

At 902, the processing circuit 502 (e.g., the hand down circuit/module 508) executing the hand down operations 514 can identify each neighboring sector associated with the first sector. In at least one example, the processing circuit 502 (e.g., the hand down circuit/module 508) executing the hand down operations 514 can identify the neighboring sectors from a Sector Parameters Message broadcast by the first sector. That is, the processing circuit 502 can receive via the communications interface 504 a Sector Parameters Message. Within the Sector Parameters Message is included a listing of the neighboring sectors.

At 904, the processing circuit 502 can tune the communications interface 504 to one of the neighboring sectors. With the communications interface 504 tuned to the neighboring sector, the processing circuit 502 (e.g., the hand down circuit/module 508) executing the hand down operations 514 can measure the signal quality (e.g., signal strength, signal-to-noise ratio (Ec/Io)) for the neighboring sector at step 906. Such a measurement can typically be performed by the processing circuit 502 via the communications interface 504.

In some examples, the processing circuit 502 (e.g., the hand down circuit/module 508) executing the hand down operations 514 may employ a threshold for the determined signal quality for the neighboring sector. Such a threshold can be used to determine whether the neighboring sector is qualified. For instance, if a neighboring sector has a signal quality that is below the threshold, the processing circuit 502 (e.g., the hand down circuit/module 508) executing the hand down operations 514 may indicate that the respective neighboring sector is not qualified. An indication as not qualified may cause the processing circuit 502 (e.g., the hand down circuit/module 508) executing the hand down operations 514 to skip an access attempt for that neighboring sector.

At 908, the processing circuit 502 (e.g., the hand down circuit/module 508) executing the hand down operations 514 can determine loading for the neighboring sector. For example, in some networks, such as an EV-DO Advanced radio access network, the base station may broadcast a Load Information Message in addition to the Sector Parameters Message. The Load Information Message includes information from which the processing circuit 502 can determine loading for each of the neighboring sectors.

At 910, the processing circuit 502 (e.g., the hand down circuit/module 508) executing the hand down operations 514 can calculate a weighting factor value for the neighboring sector based at least in part on the signal quality and the loading information for each neighboring sector. By way of example and not limitation, the weighting factor value for each neighboring sector may be calculated according to the equation

$$\frac{S * M}{L * N} ,$$

where N and M are weight factors, S represents the downlink signal quality for the neighboring sector, and L represents the load for the neighboring sector. In another example, the weighting factor value for each carrier may be calculated according to the equation

$$\frac{( S * M ) + ( L * N )}{S * L} ,$$

where N and M are again weight factors, S again represents the downlink signal quality for the neighboring sector, and L again represents the load for the neighboring sector.

At 912, the processing circuit 502 (e.g., the hand down circuit/module 508) executing the hand down operations 514 determines whether there is another neighboring sector to be evaluated. If there is, the processing circuit 502 can tune the communications interface 504 to the next neighboring sector and perform the steps 706, 708, and 710 for that neighboring sector. This can be repeated until all neighboring sectors have been evaluated.

After the last neighboring sector is evaluated, the processing circuit 502 (e.g., the hand down circuit/module 508) executing the hand down operations 514 can prioritize each neighboring sector according to the calculated weighting factor, where the neighboring sector with the best combination of good signal quality and low loading has the highest priority.

With the neighboring sector priority table generated, the processing circuit 502 can attempt to access each neighboring sector at step 812 in FIG. 8 in sequential order according to the neighboring sector priority table, where the highest priority neighboring sector is attempted first.

Referring again to FIG. 8, in another example, the processing circuit 502 (e.g., the hand down circuit/module 508) executing the hand down operations 514 may sequentially attempt accessing each neighboring sector at step 812 according to the listing of neighboring sectors from the Sector Parameters Message, without weighting the neighboring sectors for any particular priority. Thus, in this example, the processing circuit 502 can receive a Sector Parameters Message via the communications interface 504. As noted above, the Sector Parameters Message from the first sector typically includes a listing of neighboring sectors. The processing circuit 502 (e.g., the hand down circuit/module 508) executing the hand down operations 514 can accordingly attempt to sequentially access the neighboring sectors one at a time according to the listing of neighboring sectors in the Sector Parameters Message.

At step 814, the access terminal 500 determines whether access of the neighboring sectors was successfully accessed. If the access terminal 500 is able to access one of the neighboring sectors, then the access terminal 500 can end the current process and send the uplink transmissions on the successful neighboring sector, at step 810.

At step 816, if none of the neighboring sectors are successfully accessed from step 812, the access terminal 500 can hand down to the secondary radio access network. For instance, the processing circuit 502 can tune the communications interface 504 to the secondary radio access network to attempt accessing one or more carriers/sectors on that network.

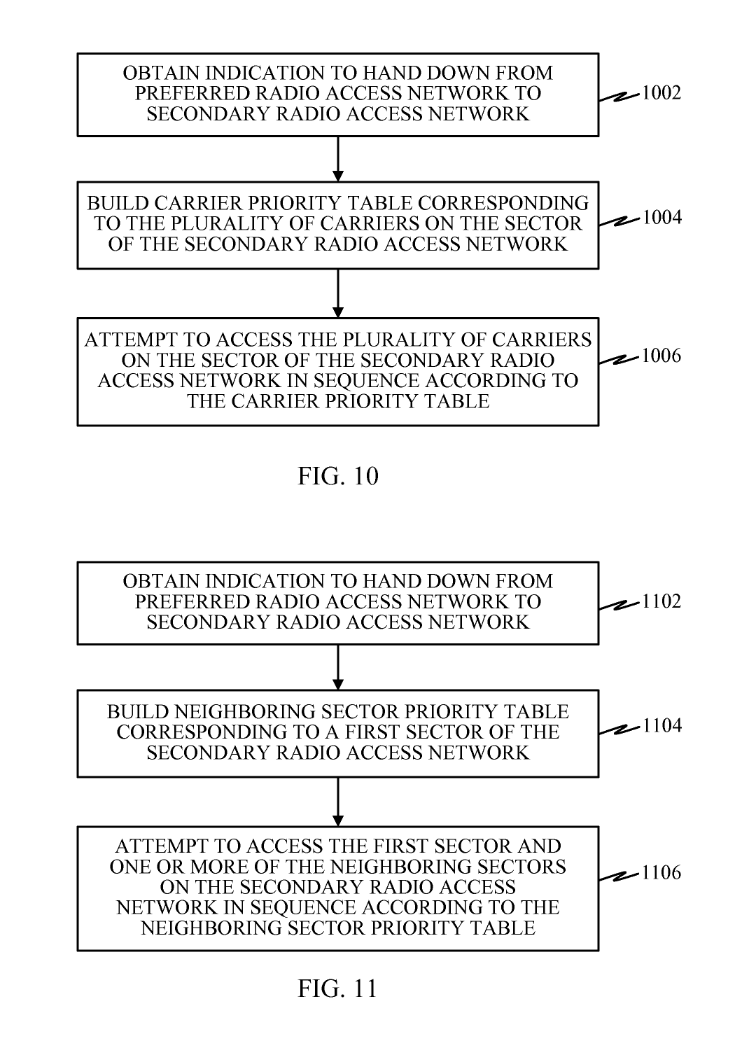

FIG. 10 is a flow diagram illustrating at least one other example of a method operational on an access terminal, such as the access terminal 500. With reference to FIGS. 5 and 10 an access terminal 500 may obtain an indication to hand down from a preferred radio access network to a secondary radio access network at step 1002. For example, the processing circuit 502 may obtain such an indication. In at least one example, the indication may be received by the processing circuit 502 via the communications interface 504 as a redirection message from the preferred radio access network. The redirection message can instruct the processing circuit 502 to hand down to the secondary radio access network. In some instances, the redirection message may indicate a carrier and/or a sector on which the access terminal 500 should attempt to access on the secondary radio access network.

At 1004, the access terminal 500 can build a carrier priority table corresponding to the plurality of carriers on the sector of the secondary radio access network. For example, the processing circuit 502 (e.g., the hand down circuit/module 508) executing the hand down operations 514 can generate a carrier priority table. In some examples, the processing circuit 502 (e.g., the hand down circuit/module 508) executing the hand down operations 514 may generate the carrier priority table in response to a failure to access an initial carrier. In at least one implementation, the processing circuit 502 (e.g., the hand down circuit/module 508) executing the hand down operations 514 may generate the carrier priority table associated with the secondary radio access network according to the process described above with reference to FIG. 7.

At step 1006, the access terminal 500 can attempt to access the plurality of carriers on the sector of the secondary radio access network in sequence according to the carrier priority table. For example, the processing circuit 502 (e.g., the hand down circuit/module 508) executing the hand down operations 514 can attempt to access the carriers one at a time on the sector of the secondary radio access network in order according to the carrier priority table.

Turning now to FIG. 11, a flow diagram is shown illustrating at least one other example of a method operational on an access terminal, such as the access terminal 500. With reference to FIGS. 5 and 11, an access terminal 500 may obtain an indication to hand down from a preferred radio access network to a secondary radio access network at step 1102. For example, the processing circuit 502 may obtain such an indication. In at least one example, the indication may be received by the processing circuit 502 via the communications interface 504 as a redirection message from the preferred radio access network. The redirection message can instruct the processing circuit 502 to hand down to the secondary radio access network. In some instances, the redirection message may indicate a carrier and/or a sector which the access terminal 500 should utilize in attempting to access the secondary radio access network.

At 1104, the access terminal 500 can build a neighboring sector priority table corresponding to a first sector of the secondary radio access network. For example, the processing circuit 502 (e.g., the hand down circuit/module 508) executing the hand down operations 514 can generate a neighboring sector priority table. In some examples, the processing circuit 502 (e.g., the hand down circuit/module 508) executing the hand down operations 514 may generate the neighboring sector priority table in response to a failure to access the first sector. In at least one implementation, the processing circuit 502 (e.g., the hand down circuit/module 508) executing the hand down operations 514 may generate the neighboring sector priority table associated with the first sector of the secondary radio access network according to the process described above with reference to FIG. 9.

At step 1106, the access terminal 500 can attempt to access the first sector and one or more of the neighboring sectors on the secondary radio access network in sequence according to the neighboring sector priority table. For example, the processing circuit 502 (e.g., the hand down circuit/module 508) executing the hand down operations 514 can attempt to initially access the first or primary sector. If unable to access the first or primary sector, the processing circuit 502 (e.g., the hand down circuit/module 508) executing the hand down operations 514 can attempt to access the neighboring sectors one at a time in order priority according to the neighboring sectors priority table.

The various aspects and features described herein can facilitate a reduction in hand down procedures, and/or improve the success when handing down occurs. Furthermore, the various aspects and features may be implemented independently or in combination with one or more other aspects and features.

While the above discussed aspects, arrangements, and embodiments are discussed with specific details and particularity, one or more of the components, steps, features and/or functions illustrated in FIGS. 1, 2, 3, 4, 5, 6, 7, 8, 9, 10, and/or 11 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, 3, and/or 4 may be configured to perform or employ one or more of the methods, features, parameters, and/or steps described in FIGS. 5, 6, 7, 8, 9, 10, and/or 11. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claims is:

1. An access terminal, comprising:
a communications interface;
a storage medium; and
a processing circuit coupled to the communications interface and the storage medium, the processing circuit adapted to:
attempt, via the communications interface, to access a first carrier on a first sector corresponding to a preferred radio access network;
in response to failure to access the first carrier, sequentially attempt to access one or more other carriers on the first sector via the communications interface before handing down to a secondary radio access network.

2. The access terminal of claim 1, wherein the processing circuit is further adapted to:
hand down to the secondary radio access network when the sequential attempt to access the one or more other carriers on the first sector fails.

3. The access terminal of claim 1, wherein the preferred radio access network is an EV-DO network, and the secondary radio access network is a cdma2000 1× network.

4. The access terminal of claim 1, wherein the processing circuit adapted to sequentially attempt to access the one or more other carriers on the first sector comprises the processing circuit adapted to:
build a carrier priority table corresponding to a plurality of carriers on the first sector;
store the carrier priority table in the storage medium; and
attempt to access the plurality of carriers on the first sector in sequence according to the carrier priority table.

5. The access terminal of claim 4, wherein the processing circuit adapted to build the carrier priority table comprises the processing circuit adapted to:
determine a weighting factor based on loading for each of the plurality of carriers on the first sector; and
prioritize each of the plurality of carriers on the first sector in accordance with the determined weighting factor for each of the plurality of carriers.

6. The access terminal of claim 5, wherein the weighting factor based on loading for each of the plurality of carriers on the first sector is based at least in part on:
a number of active connections on each respective carrier on the first sector; and
an amount of reverse link activity on each respective carrier on the first sector.

7. The access terminal of claim 1, wherein the processing circuit adapted to sequentially attempt to access the one or more other carriers on the first sector comprises the processing circuit adapted to:
receive a Sector Parameters Message via the communications interface, the Sector Parameters Message including a listing of carriers on the first sector; and
attempt to access the plurality of carriers on the first sector in sequence according to the listing of carriers included in the Sector Parameters Message.

8. A method operational on an access terminal, comprising:
engaging in a data call utilizing a first carrier on a first sector corresponding to a preferred radio access network;
idling the data call;
attempting to access the first carrier; and
prior to handing down to a secondary radio access network, attempting to sequentially access one or more other carriers on the first sector in response to failure to access the first carrier.

9. The method of claim 8, further comprising:
handing down to the secondary radio access network when the attempt to sequential access the one or more other carriers on the first sector fails.

10. The method of claim 8, wherein attempting to sequentially access the one or more other carriers on the first sector in response to failure to access the first carrier comprises:
building a carrier priority table corresponding to a plurality of carriers on the first sector; and
attempting to access the plurality of carriers on the first sector in sequence according to the carrier priority table.

11. The method of claim 10, wherein building the carrier priority table corresponding to the plurality of carriers on the first sector comprises:
determining a number of active connections on each of the plurality of carriers on the first sector;
determining an amount of reverse link activity on each of the plurality of carriers on the first sector;
calculating a weighting factor for each of the plurality of carriers on the first sector based at least in part on the respective number of active connections and the respective amount of reverse link activity on each carrier on the first sector; and
prioritizing each of the plurality of carriers on the first sector in accordance with the respective weighting factors.

12. The method of claim 11, wherein determining the amount of reverse link activity on each of the plurality of carriers on the first sector comprises:
monitoring a reverse activity bit for a period of time; and
determining a percentage of time the reverse activity bit is set to 1 during the period of time.

13. The method of claim 8, wherein attempting to sequentially access the one or more other carriers on the first sector in response to failure to access the first carrier comprises:
receiving a Sector Parameters Message including a list of carriers on the first sector; and
attempting to access the plurality of carriers on the first sector in sequence according to the list of carriers in the Sector Parameters Message.

14. A processor-readable storage medium, comprising programming for causing a processing circuit to:
engage in a data call utilizing a first carrier on a first sector corresponding to a preferred radio access network;
idle the data call;
attempt to access the first carrier; and
prior to handing down to a secondary radio access network, attempt to sequentially access one or more other carriers on the first sector in response to failure to access the first carrier.

15. An access terminal, comprising:
a communications interface;
a storage medium; and
a processing circuit coupled to the communications interface and the storage medium, the processing circuit adapted to:
attempt, via the communications interface, to access a first sector corresponding to a preferred radio access network;
in response to failure to access the first sector, sequentially attempt to access one or more neighboring sectors via the communications interface prior to handing down to a secondary radio access network.

16. The access terminal of claim 15, wherein the processing circuit is further adapted to:
hand down to the secondary radio access network when the sequential attempt to access the one or more neighboring sectors fails.

17. The access terminal of claim 15, wherein the preferred radio access network is an EV-DO network, and the secondary radio access network is a cdma2000 1× network.

18. The access terminal of claim 15, wherein the processing circuit adapted to sequentially attempt to access the one or more neighboring sectors comprises the processing circuit adapted to:
build a neighboring sector priority table corresponding to one or more neighboring sectors of the first sector;
store the neighboring sector priority table in the storage medium; and
attempt to access the one or more neighboring sectors in sequence according to the neighboring sector priority table.

19. The access terminal of claim 18, wherein the processing circuit adapted to build the neighboring sector priority table comprises the processing circuit adapted to:
identify one or more neighboring sectors;
measure a signal quality for each of the identified neighboring sectors;
determine loading corresponding to each of the identified neighboring sectors;
determine a weighting factor for each of the identified neighboring sectors based at least in part on the respective signal quality and the respective loading information for each neighboring sector; and
prioritize each of the neighboring sectors in accordance with the determined weighting factor for each of the identified neighboring sectors.

20. The access terminal of claim 19, wherein the processing circuit is adapted to identify the one or more neighboring sectors from a Sector Parameters Message received via the communications interface.

21. The access terminal of claim 19, wherein the processing circuit is adapted to determine the loading corresponding to each of the identified neighboring sectors from a Load Information Message received via the communications interface.

22. The access terminal of claim 15, wherein the processing circuit adapted to sequentially attempt to access the one or more neighboring sectors comprises the processing circuit adapted to:
receive a Sector Parameters Message from the first sector via the communications interface, the Sector Parameters Message including a listing of neighboring sectors; and
attempt to access the one or more neighboring sectors in sequence according to the listing of neighboring sectors included in the Sector Parameters Message.

23. A method operational on an access terminal, comprising:
engaging in a data call utilizing a carrier on a first sector corresponding to a preferred radio access network;
idling the data call;
attempting to access the first sector; and
prior to handing down to a secondary radio access network, attempting to sequentially access one or more neighboring sectors in response to failure to access the first sector.

24. The method of claim 23, further comprising:
handing down to the secondary radio access network in response to failure to access the one or more neighboring sectors fails.

25. The method of claim 23, wherein attempting to sequentially access one or more neighboring sectors comprises:
building a neighboring sector priority table corresponding to one or more neighboring sectors of the first sector; and
attempting to access the one or more neighboring sectors in sequence according to the neighboring sector priority table.

26. The method of claim 25, wherein building the neighboring sector priority table comprises:
determining a weighting factor for each of the neighboring sectors; and
prioritizing each of the neighboring sectors in accordance with the determined weighting factors.

27. The method of claim 26, wherein determining the weighting factor for each of the neighboring sectors comprises;
measuring a signal quality for each of the neighboring sectors;
determining loading corresponding to each of the neighboring sectors;
calculating a weighting factor for each neighboring sector based at least in part on the respective signal quality and the respective loading information for each neighboring sector.

28. The method of claim 27, wherein determining the loading corresponding to each of the neighboring sectors comprises:
receiving a Load Information Message; and
determining the loading corresponding to one or more neighboring sectors from the Load Information Message.

29. The method of claim 23, wherein attempting to sequentially access one or more neighboring sectors comprises:
receiving a Sector Parameters Message including a listing of neighboring sectors; and
attempting to access the one or more neighboring sectors in sequence according to the listing of neighboring sectors included in the Sector Parameters Message.

30. A processor-readable storage medium, comprising programming for causing a processing circuit to:
attempt to access a first sector corresponding to a preferred radio access network; and
prior to handing down to a secondary radio access network, attempt to sequentially access one or more neighboring sectors in response to failure to access the first sector.

31. An access terminal, comprising:
a communications interface;
a storage medium; and
a processing circuit coupled to the communications interface and the storage medium, the processing circuit adapted to:
obtain an indication to hand down from a preferred radio access network to a secondary radio access network;
build a carrier priority table corresponding to a plurality of carriers on a sector of the secondary radio access network; and
attempt to access the plurality of carriers on the sector of the secondary radio access network in sequence according to the carrier priority table.

32. The access terminal of claim 31, wherein the indication to hand down from the preferred radio access network to the secondary radio access network comprises a redirection message received from the preferred radio access network, and wherein the processing circuit is adapted to:
attempt to access a first carrier of the sector indicated by the redirection message; and
build the carrier priority table in response to a failure to access the first carrier indicated by the redirection message.

33. The access terminal of claim 31, wherein the processing circuit adapted to build the carrier priority table comprises the processing circuit adapted to:
identify the plurality of carriers on the sector of the secondary radio access network;
determine a weighting factor based on loading for each of the plurality of carriers on the sector; and
prioritize each of the plurality of carriers on the sector in accordance with the determined weighting factor for each of the plurality of carriers.

34. The access terminal of claim 33, wherein the weighting factor based on loading for each of the plurality of carriers on the sector is based at least in part on:
a number of active connections on each respective carrier on the sector; and
an amount of reverse link activity on each respective carrier on the sector.

35. The access terminal of claim 34, wherein, to determine the amount of reverse link activity on each respective carrier on the sector, the processing circuit is adapted to:
monitor a reverse activity bit for a period of time; and
determine a percentage of time the reverse activity bit is set to 1 during the period of time.

36. The access terminal of claim 31, wherein the preferred radio access network comprises an LTE radio access network, and the secondary radio access network comprises an EV-DO radio access network.

37. A method operational on an access terminal, comprising:
obtaining an indication to hand down from a preferred radio access network to a secondary radio access network;
building a carrier priority table corresponding to a plurality of carriers on a sector of the secondary radio access network; and
attempting to access the plurality of carriers on the sector of the secondary radio access network in sequence according to the carrier priority table.

38. The method of claim 37, wherein obtaining the indication to hand down from the preferred radio access network to the secondary radio access network comprises:
receiving a redirection message from the preferred radio access network.

39. The method of claim 38, wherein the redirection message indicates a first carrier of the sector to attempt to access, and the method further comprises:
attempting to access the first carrier of the sector indicated by the redirection message; and
building the carrier priority table in response to failure to access the first carrier indicated by the redirection message.

40. The method of claim 37, wherein building the carrier priority table corresponding to the plurality of carriers on the sector comprises:
identifying the plurality of carriers on the sector of the secondary radio access network;
determining a weighting factor based on loading for each of the plurality of carriers on the sector; and
prioritizing each of the plurality of carriers on the sector in accordance with the determined weighting factor for each of the plurality of carriers.

41. The method of claim 40, wherein determining the weighting factor based on loading for each of the plurality of carriers on the sector comprises:
determining a number of active connections on each of the plurality of carriers on the first sector;
determining an amount of reverse link activity on each of the plurality of carriers on the first sector; and
calculating the weighting factor for each of the plurality of carriers on the first sector based at least in part on the respective number of active connections and the respective amount of reverse link activity on each carrier on the first sector.

42. The method of claim 41, wherein determining the amount of reverse link activity on each of the plurality of carriers on the first sector comprises:
monitoring a reverse activity bit for a period of time; and
determining a percentage of time the reverse activity bit is set to 1 during the period of time.

43. A processor-readable storage medium, comprising programming for causing a processing circuit to:
obtain an indication to hand down from a preferred radio access network to a secondary radio access network;
build a carrier priority table corresponding to a plurality of carriers on a sector of the secondary radio access network; and
attempt to access the plurality of carriers on the sector of the secondary radio access network in sequence according to the carrier priority table.

44. An access terminal, comprising:
a communications interface;
a storage medium; and
a processing circuit coupled to the communications interface and the storage medium, the processing circuit adapted to:
obtain an indication to hand down from a preferred radio access network to a secondary radio access network;
build a neighboring sector priority table corresponding to a first sector of the secondary radio access network; and
attempt to access the first sector and the one or more neighboring sectors on the secondary radio access network in sequence according to the neighboring sector priority table.

45. The access terminal of claim 44, wherein the indication to hand down from the preferred radio access network to the secondary radio access network comprises a redirection message received from the preferred radio access network, the redirection message including an identification of the first sector as an initial sector to be accessed, and wherein the processing circuit is adapted to:
attempt to access the first sector indicated by the redirection message; and
build the neighboring sector priority table in response to a failure to access the first sector indicated by the redirection message.

46. The access terminal of claim 44, wherein the processing circuit adapted to build the neighboring sector priority table comprises the processing circuit adapted to:
identify one or more neighboring sectors;
measure a signal quality for each of the identified neighboring sectors;
determine loading corresponding to each of the identified neighboring sectors;
determine a weighting factor for each of the identified neighboring sectors based at least in part on the respective signal quality and the respective loading information for each neighboring sector; and
prioritize each of the neighboring sectors in accordance with the determined weighting factor for each of the identified neighboring sectors.

47. The access terminal of claim 46, wherein the processing circuit is adapted to identify the one or more neighboring sectors from a Sector Parameters Message received via the communications interface.

48. The access terminal of claim 46, wherein the processing circuit is adapted to determine the loading corresponding to each of the identified neighboring sectors from a Load Information Message received via the communications interface from the secondary radio access network.

49. A method operational on an access terminal, comprising:
obtaining an indication to hand down from a preferred radio access network to a secondary radio access network;
building a neighboring sector priority table corresponding to a first sector of the secondary radio access network; and
attempting to access the first sector and the one or more neighboring sectors on the secondary radio access network in sequence according to the neighboring sector priority table.

50. The method of claim 49, wherein obtaining the indication to hand down from the preferred radio access network to the secondary radio access network comprises:
receiving a redirection message from the preferred radio access network.

51. The method of claim 50, wherein the redirection message identifies the first sector as an initial sector to attempt to access, and the method further comprises:
attempting to access the first sector indicated by the redirection message; and
building the neighboring sector priority table in response to failure to access the first sector indicated by the redirection message.

52. The method of claim 49, wherein building the neighboring sector priority table comprises:
determining a weighting factor for each of the neighboring sectors; and
prioritizing each of the neighboring sectors in accordance with the determined weighting factors.

53. The method of claim 52, wherein determining the weighting factor for each of the neighboring sectors comprises;
measuring a signal quality for each of the neighboring sectors;
determining loading corresponding to each of the neighboring sectors;
calculating a weighting factor for each neighboring sector based at least in part on the respective signal quality and the respective loading information for each neighboring sector.

54. The method of claim 53, wherein determining the loading corresponding to each of the neighboring sectors comprises:
receiving a Load Information Message; and
determining the loading corresponding to one or more neighboring sectors from the Load Information Message.

55. A processor-readable storage medium, comprising programming for causing a processing circuit to:
obtain an indication to hand down from a preferred radio access network to a secondary radio access network;
build a neighboring sector priority table corresponding to a first sector of the secondary radio access network; and
attempt to access the first sector and the one or more neighboring sectors on the secondary radio access network in sequence according to the neighboring sector priority table.
